(19) United States
(12) Patent Application Publication
(10) Pub. No.: US 2012/0233130 A1
(43) Pub. Date: Sep. 13, 2012

(54) SYSTEM AND METHOD FOR ARCHIVING EMAILS

(76) Inventors: Nagarajan Vedachalam, TamilNadu (IN); Rukumani Canniappin, Pondicherry (IN)

(21) Appl. No.: 13/046,185

(22) Filed: Mar. 11, 2011

(51) Int. Cl. G06F 17/30

(52) U.S. Cl. 707/673; 707/E17.005

(57) ABSTRACT

A method and system for storing and distributing emails in an organization having a plurality of email users. The method comprises the steps of: Encrypting and compressing emails from at least one email collection center and transferring said encrypted and compressed emails through a network based system; extracting, decrypting and indexing the contents, properties and any attachments of the emails transferred from the at least one email collection center; and providing an archival access application by which individual users are able to conduct term-based searches for and retrieve one or more specific ones of their own indexed emails via multiple web clients, wherein the terms of said term-based searches include one or more terms associated with one or more of at least the subject, sender, recipient, body and attachments of the indexed emails.

### FIELD OF THE INVENTION

The present invention generally relates to systems and methods for archiving electronic correspondence, such as emails, in an organization, such as a business, to facilitate accessing such correspondence from remote locations, including access to the correspondence of former account holders, such as former employees of the organization.

### BACKGROUND OF THE INVENTION

Email archiving is the process of preserving and facilitating the searching of email contents and attachments in various formats, as well as the retrieval of those contents and attachments by the user using the applications corresponding to the various formats. Conventional archiving solutions capture email content either directly from an email application itself or during transport. The email messages are typically then stored on magnetic disk storage and indexed to simplify future searches. These various aspects of conventional archiving systems are resident within an organization, whether in the same geographic location or as part of the organizations computer network. While such conventional archiving solutions represent an improvement over non-archived email systems, they nevertheless have a number of drawbacks, including speed of email retrieval and operating expense. For instance, conventional archiving systems are not efficient enough to provide quick search results or efficient batch processing of emails while archiving.

### SUMMARY OF THE DISCLOSURE

The present disclosure comprehends a method and system for archiving emails in an organization having a plurality of email users. The disclosed method comprises the steps of: Encrypting and compressing emails from at least one email collection center and transferring said encrypted and compressed emails through a network based system to storage; extracting, decrypting, and indexing the contents, properties and any attachments of the emails transferred from the at least one email collection center; and providing an archival access application by which individual users are able to conduct term-based searches for and retrieve one or more specific ones of their own indexed emails via multiple web clients, wherein the terms of the term-based searches include one or more terms associated with one or more of at least the subject, sender, recipient, body and attachments of the indexed emails.

According to one feature, the method further comprises the step of balancing demand on the web clients by multiple users.

Per another feature, only one or more preselected users are able to search for and retrieve any of the indexed emails. Such preselected user or users may, in one form, be a system administrator for the email system.

According to still another feature, the step of decrypting, extracting and indexing emails is carried out via multiple indexing engines operating in parallel.

Per yet another feature, the method comprises the further step of separating and separately storing the attachments of indexed emails. The step of separating and separately storing the attachments of indexed emails may further comprise maintaining in the indexed emails any hyperlinks to the separated and separately stored attachments. According to one feature, the step of separately storing the attachments of the indexed emails comprises storing said attachments in archival storage.

The system of the present invention is a system for storing and distributing emails in an organization having a plurality of email users, comprising: at least one email collection center from which emails are encrypted and compressed; a network-based system through which the compressed and encrypted emails are transferred for storage; multiple indexing engines, operating in parallel, to decrypt, extract and index the contents, properties and any attachments of the emails transferred from the at least one email collection center through a network to a storage system; and

an archival access application by which individual users are able to conduct term-based searches for and retrieve one or more specific ones of their own indexed emails via multiple web clients, wherein the terms of said term-based searches include one or more terms associated with one or more of at least the subject, sender, recipient, body and attachments of the indexed emails.

Per one feature, the system further comprises at least one load balancer for balancing user demand on the archival access application by said multiple web clients.

Per another feature of the system, only one or more preselected users are able to search for and retrieve any of the indexed emails. The one or more preselected users may, per one feature of the invention, be a system administrator of the email system.

According to still another feature of the invention, the attachments of indexed emails are separated, and stored separately from, the indexed emails. In one form of the invention, the attachments of the indexed emails are separately stored in archival storage. Per a further feature, hyperlinks in the indexed emails to the separated and separately stored attachments are maintained.

### BRIEF DESCRIPTION OF THE DRAWINGS

For a better understanding of the invention, and to show more clearly how it may be carried into effect according to one or more embodiments thereof, reference will now be made, by way of example, to the accompanying drawings, showing exemplary embodiments of the present invention and in which:

FIG. 1 is a diagram illustrating an email capture and archiving system according to one embodiment of the present invention; and

FIG. 2 is a flowchart exemplifying the operation of the inventive system in facilitating access to the emails of an organization's former employees.

### DETAILED DESCRIPTION

As required, a detailed description of the present invention is disclosed herein. However, it is to be understood that the disclosed embodiment is merely exemplary of the invention that may be embodied in various and alternative forms. Therefore, specific structural and functional details disclosed herein are not to be interpreted as limiting, but merely as a representative basis for teaching one skilled in the art to variously employ the present invention.

The accompanying drawings are not necessarily to scale, and some features may be exaggerated or minimized to show details of particular components.

It will be appreciated that the systems and methods of the present invention are described below with reference to the accompanying diagrams. It should be understood that these diagrammatic illustrations may be implemented by computer program instructions. These computer program instructions may be loaded onto a general purpose computer, special purpose computer, or other programmable data processing apparatus to produce a mechanism, such that the instructions executed on the computer or other programmable data processing apparatus create means for implementing the functions specified in the diagrams and the written description herein.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the diagrams and the written description herein. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the diagrams and the written description herein.

Accordingly, the diagrammatic illustrations support combinations of means for performing the specified functions, combinations of steps for performing the specified functions and program instruction means for performing the specified functions. It will also be understood that the diagrammatic illustrations can be implemented by special purpose hardware-based computer systems that perform the specified functions or steps, or combinations of special purpose hardware and computer instructions.

Reference is made herein to “cloud-network” based systems, by which term is meant Internet-based systems wherein shared servers provide resources, software, and/or data to computers and other devices on demand. Such systems are commonly referred to as “cloud computing,” and the Internet-based network as “the cloud.” In one embodiment, the present invention may optionally be implemented in a cloud-network system.

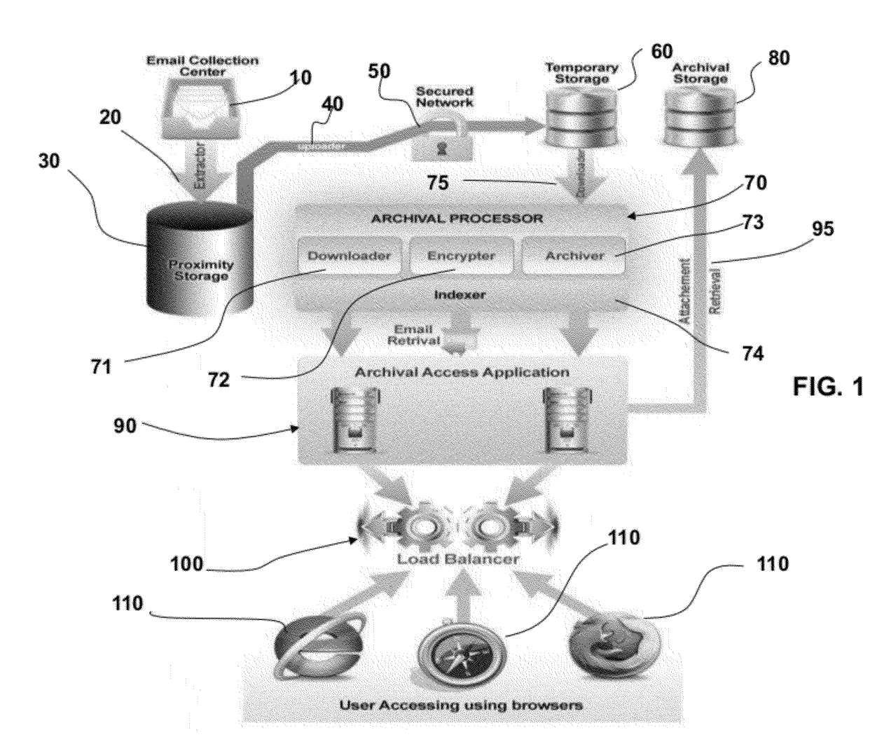

Referring then to FIG. 1, the present invention generally comprehends a method and system for storing and distributing emails in an organization having a plurality of email users. The system of the present invention generally comprises at least one email collection center (e.g., an email server) 10 from which emails are extracted 20 and then securely uploaded to temporary storage 60 (which may optionally comprise cloud-based storage); one or more archival processors 70 which download, encrypt and index the contents, properties and any attachments of the emails downloaded from temporary storage 60 and then transfer those contents to archival storage 80 (which may optionally comprise cloud-based storage); and an archival access application 90 by which individual users are able to conduct term-based searches for and retrieve one or more specific ones of their own indexed emails via multiple web clients 110. At least one load balancer 100 is also provided for balancing user demand of the archival access application 90 via the multiple web clients 110.

More particularly, the present invention, according to the exemplary embodiment thereof, is comprised of the following components, which may be disposed in a single server or distributed in multiple servers, either as a single component or as multiple components, with the indicated functionalities:

An email collection center 10, which comprises the centralized server where all the email communications of the organization (e.g., business) are made available. Collection center 10 may be any processor-driven device, such as a personal computer, laptop computer, dedicated server, etc. as per convention.

An extractor 20, which is the system component that breaks down each email into multiple constituent parts for storage. These multiple constituent parts include: The email metadata in the form of the XML manifest file (manifest.xml); any email attachments; and the complete email (less any attachments). The XML manifest file contains one or more emails' metadata contents based on the following configuration set; namely, the location of the email collection center (e.g., 10); the location where the multiple part files to be created; and the number of email documents to be collated in a single manifest XML file. The email metadata comprises the following information: A unique id; an email initiator; the email recipient(s) information from the “To,” “Copy To,” and “Blind Copy To” fields; the email posted date; the subject of the email; the text from the body of the email; the files names of any attachments to the email; and the email message ID.

Notably, the extractor 20 can be triggered manually or instantaneously on receipt of one or more emails at the email collection center 10, or periodically one or more times a day, week, etc. The successful extraction of email documents will be tracked using a flag, which avoids duplicity of extractor efforts. On completion of its task, the extractor 20 generates a finished file in the proximity (i.e., local) storage 30.

Uploader 40 polls for the finished file created by the extractor in local storage. On identifying a finished file, the uploader 40 compresses the files in the part, transfers it through a secured network 50 and stores them in a temporary storage 60. A secure transmission mechanism encrypts the transferred compressed part files. On successful uploading of the part file to temporary storage 60, the finished file is deleted from the proximity storage 30.

An archival processor 70 comprising each of a downloader 71, an encrypter 72, an archiver 73, and an indexer 74. The downloader 71 constantly monitors the temporary storage 60 for any new compressed part files via a simple queue mechanism. On successful identification of compressed files in the temporary storage 60, downloader 71 downloads 75 the contents and extracts them to a uniquely named temporary directory in the system where it is running. It also sends a request to the indexer 74 for indexing the XML manifest file.

The encrypter 72 component of archival processor 70 works on the attachment files downloaded from the extracted contents in a separate folder. Encrypter 72 encrypts and stores every attachment file to an attachments folder of the permanent, archival storage 80. Encryption of the emails and their related attachments may be accomplished via any conventional software, although per the exemplary embodiment the BLOWFISH encryption algorithm, utilized in a range of commercially available encryption products, is presently preferred for its efficiency.

The indexer 74 assists indexing of the XML manifest file when all the attachments of that part are completed by the encrypter 72. Indexing may, for instance, be accomplished via any conventional indexing software. The archiver 73 transfers all the contents to the archival storage 80 following successful indexing by the indexer 74. Archival storage 80 may, by way of example, comprise the SIMPLE STORAGE SERVICE (“S3”) commercially available from Amazon Web Services, LLC.

From the foregoing, it will be appreciated that the attachments are separately stored from the emails.

As will be appreciated by those skilled in the art, the number of archival processors 70 required is determined by the requirements of the organization (e.g., business, organization, etc.).

The archival access application 90 is an internet-browser-based application, accessible via multiple web clients 110 using conventional web browser applications. Via such web browser interface, the archival access application 90 validates a system-user's credentials and, upon validation, provides the user access to view his/her archived emails and any attachments associated with it. The archival access application enables user search queries that facilitate term-based searches of the indexed email contents, and comprehend one or more terms associated with one or more of at least the subject, sender, recipient, body, dates or date ranges, and attachments of the indexed emails. The interface may enable free-form search queries—i.e., search queries defined by a user—and/or search queries developed with one or more predefined filters, such as, for instance, search queries comprehending one or more of at least the subject, sender, recipient, body, internet domains, dates or date ranges, and attachments of the indexed emails, wherein the user selects from one or more predefined filters (e.g., “date,” “date range,” “sender,” “recipient,” etc.) and inputs (or selects from a predefined list) data pertinent to each of the one or more selected filters. Furthermore, the one or more predefined filters may identify terms of exclusion, to thereby exclude from the search results emails whose indexed data matches one or more of the exclusion criteria. The application may, optionally, be integrated with SSO (Single Sign On), multiple language support libraries, policy adherence, etc. When a user requests an attachment using the archival access web application 90, a request is made to the attachment retriever from the application. The attachment retriever retrieves 95 the attachments from the archival storage 80, decrypts the retrieved attachment file(s) and delivers it to the user.

It will be appreciated that such web clients and users may be widely geographically separated throughout an organization.

Finally, to ensure that system resources are optimally utilized, and to maximize throughput and minimize response time, the system may optionally incorporate conventional load balancing software, including, as desired, in the form of dedicated, conventional hardware such as load balancer 100.

Per the exemplary embodiment of the invention, the various components described above are part of an Internet-based communication network, whereby these various components are in electrical communication to permit operation of the system and method in the manner described herein. As will be appreciated, the at least one email collection center 10 is provided in a first location, such as at an organization's place of business, while the other system elements, including at least the temporary and archival storage 60, 80, archival access application 90 and multiple web clients 110, are provided in one or more locations geographically remote from the at least one email collection center 10.

In summary, operation of the foregoing is as follows: Manually or instantaneously on receipt of one or more emails at the email collection center 10, or periodically one or more times a day, week, etc., extractor 20 breaks down each email into its multiple constituent parts for storage. On completion of its task, the extractor 20 generates a finished file in the proximity (i.e., local) storage 30.

Uploader 40 polls for the finished file created by the extractor in local storage. On identifying a finished file, the uploader 40 compresses the files in the part, transfers it through a secured network 50 and stores them in temporary storage 60. On successful uploading of the part file to temporary storage 60, the finished file is deleted from the proximity storage 30.

On the identification of compressed files in the temporary storage 60, downloader 71 downloads 75 the contents and extracts them to a uniquely named temporary directory in the system where it is running. It also sends a request to the indexer 74 for indexing the XML manifest file.

The encrypter 72 component of archival processor 70 works on the attachment files downloaded from the extracted contents in a separate folder. Encrypter 72 encrypts and stores every attachment file to an attachments folder of the permanent, archival storage 80.

The indexer 74 assists indexing of the XML manifest file when all the attachments of that part are completed by the encrypter 72.

The archiver 73 transfers all the contents to the archival storage 80 following successful indexing by the indexer 74.

Via multiple web clients 110 using conventional web browser applications, users can search and retrieve emails and their attachments using the archival access application 90. When a user requests an attachment using the archival access web application 90, a request is made to the attachment retriever from the application. The attachment retriever retrieves 95 the attachments from the archival storage 80, decrypts the retrieved attachment file(s) and delivers it to the user.

Optionally, only one or more preselected users, such as system administrators, for example, are able to search for and retrieve any of the archived emails (via the archival access application 90 using a web client 110), while other users are able to search for and retrieve (also via the archival access application 90 using a web client 110) only their own (i.e., where such user was sender and/or recipient) archived emails. By having one or more such preselected users, it will be understood that access to the emails of an organization's departed employees is possible, thus facilitating business continuity even in the absence of one or more employees.

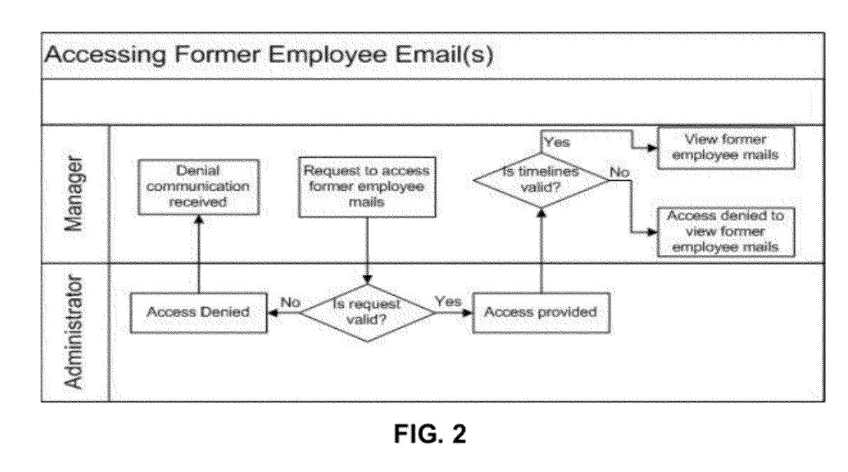

Still further, it is contemplated that one or more such preselected users (e.g., system administrators) may be empowered to delegate broader search and retrieval rights to other users. Referring to FIG. 2, one manner of facilitating such access among such users is exemplified.

More particularly, FIG. 2 depicts a scheme wherein a preselected user in the form of an administrator is empowered both to search all emails of the organization's users, as well as to empower others to conduct searches of a former employee's emails on a more limited basis. According to the protocol shown in FIG. 2, the user (“Manager”) requests of the preselected user (“Administrator”) to access the former employee's emails. The Administrator will review the request to determine if the same is valid based upon appropriate criteria (e.g., that the Manager is a current employee and was in a position of authority over the former employee) and, if the request is valid, will provide the Manager with access to the former employee's emails. If the request is not valid, then, as shown in FIG. 2, access to the former employee's emails is denied and the denial of access is communicated to the requesting Manager. Once access is provided, it can be seen from FIG. 2 that the system is enabled to permit the Manager's access to the former employee's emails only during a valid timeline of the former employee's employment with the organization (e.g., during a time period in which the former employee was under the Manager's supervision). Where the parameters of the Manager's search do not fall within such a valid timeline, access to the former employee's emails is denied; whereas, if the parameters of the Manager's search do fall within a valid timeline, access to the former employee's emails is permitted. Discrimination between valid and invalid timeline parameters may be a program component of the archival access application 90, described above, according to which it will be appreciated that employee data enabling validation of the requested search timeline would have to be supplied to the application 90.

By the foregoing system and methodology, it will be appreciated that the present invention addresses numerous drawbacks associated with conventional “on-site” email archiving, including reducing an organization's capital expenditures and other costs by transferring email archiving to the cloud, thereby eliminating the need for “on-site” storage and indexing systems and personnel to operate and maintain such systems. Moreover, by utilizing cloud-based systems, it will be appreciated that the archiving system of the present invention permits virtually unlimited scalability to accommodate an organization's changing requirements as its grows or contracts. Likewise, it will be appreciated that the cloud-based system architecture herein disclosed permits an organization's employees to access archived emails from virtually any web client at any time. Finally, the inventive archiving system provides for the secure, remote storage of emails, thereby safeguarding an organization against data loss due to on-site system failures, damage or loss of hardware, etc.

The foregoing description of the exemplary embodiment of the invention has been presented for purposes of illustration and description. It is not intended to be exhaustive of, or to limit, the invention to the precise form disclosed, and modification and variations are possible in light of the above teachings or may be acquired from practice of the invention. The embodiment shown are described in order to explain the principles of the invention and its practical application to enable one skilled in the art to utilize the invention in various embodiments and with various modifications as are suited to the particular application contemplated. Accordingly, all such modifications and embodiments are intended to be included within the scope of the invention. Other substitutions, modifications, changes and omissions may be made in the design, operating conditions, and arrangement of the exemplary embodiments without departing from the spirit of the present invention.

The invention in which an exclusive property or privilege is claimed is defined as follows:

1. A method for storing and distributing emails in an organization having a plurality of email users, comprising the steps of:
encrypting and compressing emails from at least one email collection center and transferring said compressed and encrypted emails through a network based system;
extracting, decrypting and indexing the contents, properties and any attachments of the emails transferred from the at least one email collection center; and
providing an archival access application by which individual users are able to conduct term-based searches for and retrieve one or more specific ones of their own indexed emails via multiple web clients, wherein the terms of said term-based searches include one or more terms associated with one or more of at least the subject, sender, recipient, body and attachments of the indexed emails.

2. The method of claim 1, further comprising the step of balancing demand on the web clients by multiple users.

3. The method of claim 1, wherein only one or more select users are able to search for and retrieve any of the indexed emails.

4. The method of claim 3, wherein the one or more select users is a system administrator.

5. The method of claim 1, wherein the step of decrypting, extracting and indexing emails is carried out via multiple indexing engines operating in parallel.

6. The method of claim 1, further comprising the step of separating and separately storing the attachments of indexed emails.

7. The method of claim 6, wherein the step of separating and separately storing the attachments of indexed emails further comprises maintaining in the indexed emails any hyperlinks to the separated and separately stored attachments.

8. The method of claim 6, where the step of separately storing the attachments of the indexed emails comprises storing said attachments in archival storage.

9. A system for storing and distributing emails in an organization having a plurality of email users, comprising:
at least one email collection center from which emails are encrypted and compressed;
a network-based system through which the compressed and encrypted emails are transferred for storage;
multiple indexing engines, operating in parallel, to decrypt, extract and index the contents, properties and any attachments of the emails transferred from the at least one email collection center through a network to a storage system; and
an archival access application by which individual users are able to conduct term-based searches for and retrieve one or more specific ones of their own indexed emails via multiple web clients, wherein the terms of said term-based searches include one or more terms associated with one or more of at least the subject, sender, recipient, body and attachments of the indexed emails.

10. The system of claim 9, further comprising at least one load balancer for balancing user demands on the said multiple web clients.

11. The system of claim 9, wherein only one or more select users are able to search for and retrieve any of the indexed emails.

12. The system of claim 11, wherein the one or more select users is a system administrator.

13. The system of claim 9, wherein further the attachments of indexed emails are separated, and stored separately from, the indexed emails.

14. The system of claim 13, wherein any hyperlinks in the indexed emails to the separated and separately stored attachments are maintained.

15. The system of claim 13, wherein the attachments of the indexed emails are separately stored in archival storage.
